(19) United States
(12) Patent Application Publication
(10) Pub. No.: US 2024/0360017 A1
(43) Pub. Date: Oct. 31, 2024

(54) FULL-PROCESS AUTOMATIC CONTROL SYSTEM AND METHOD BASED ON SLUDGE DUAL-REFLUX AOA PROCESS

(71) Applicant: BEIJING ENTERPRISES WATER GROUP LIMITED, Beijing (CN)

(72) Inventors: XIAOYAN YAO, Beijing (CN); LINGYUN LI, Beijing (CN); XIAOFEI XUE, Beijing (CN); WEIHANG LIU, Beijing (CN)

(21) Appl. No.: 18/292,902

(22) PCT Filed: Dec. 2, 2021
(86) PCT No.: PCT/CN2021/135052

§ 371 Date: Jan. 27, 2024

(30) Foreign Application Priority Data
Jul. 28, 2021 (CN) 202110859346.7
Jul. 28, 2021 (CN) 202121732574.X

(51) Int. Cl. C02F 3/00; C02F 3/30

(52) U.S. Cl. CPC C02F 3/006; C02F 3/303; C02F 2203/006; C02F 2209/006; C02F 2209/08; C02F 2209/10; C02F 2209/14; C02F 2209/22; C02F 2209/38; C02F 2209/40; C02F 2209/42; C02F 2301/046

(57) ABSTRACT

The present application provides a full-process automatic control system and method based on a sludge double recirculation Anaerobic-Anoxic-Oxic (AOA) process. The system includes an anaerobic tank, an aerobic tank, an anoxic tank, a sedimentation tank, a monitoring system, an aeration system, a sludge discharge system, and a control system. The anaerobic tank, the aerobic tank, the anoxic tank, and the sedimentation tank are sequentially communicated. A sludge reflux port of the sedimentation tank is communicated with the anaerobic tank and the anoxic tank through a first sludge reflux pipe and a second sludge reflux pipe respectively. The monitoring system includes a water inlet flowmeter, a Chemical Oxygen Demand (COD) analyzer, NH3-N analyzers, a Dissolved Oxygen (DO) monitor, Mixed Liquor Suspended Solid (MLSS) analyzers, a gas flowmeter, a first reflux sludge flowmeter, a second reflux sludge flowmeter, and a sludge level meter that are all in communication connection with the control system. According to the full-process automatic control system provided by the present application, operation parameters of the sludge double recirculation AOA process are controlled more intelligently, so that the process is kept at the optimal operation parameters, meanwhile, the energy consumption is reduced, the control is flexible, the operations are convenient, the manual operations are reduced, and the operation efficiency is improved.

### TECHNICAL FIELD

The present application relates to the technical field of environmental protection, and in particular, to a full-process automatic control system and method based on a sludge double recirculation Anaerobic-Anoxic-Oxic (AOA) process.

### BACKGROUND

A sludge double recirculation AOA process is a novel efficient denitrification process. The process includes an anaerobic tank, an aerobic tank, an anoxic tank that are sequentially connected. Sludge refluxes in two ways. One way refluxes to a front end of the anaerobic tank, and the other way refluxes to a front end of the anoxic tank. In the process, second reflux sludge refluxed to the anoxic tank not only provides an internal carbon source for denitrification in the anoxic tank, but also increases the quantity of denitrifying bacteria in the anoxic tank. The process does not require an external carbon source, has high denitrification efficiency, and is particularly suitable for denitrification of wastewater with a low carbon-to-nitrogen ratio. At present, the running of sewage treatment plants in China is mainly based on manual operations according to experiences or is in a simple automatic control method that can realize equipment start and stop and fault alarm. Therefore, developing a full-process automatic control system and method based on a sludge double recirculation AOA process is crucial for the meticulous running of the process, the improvement of the operation efficiency, and the expansion, promotion, and application.

### SUMMARY

The present application provides a full-process automatic control system and method based on a sludge double recirculation AOA process to solve above problems.

The present application is specifically as follows:

Based on the above purpose, the present embodiment provides a full-process automatic control system based on a sludge double recirculation AOA process, including:
an anaerobic tank, an aerobic tank, an anoxic tank, a sedimentation tank, a monitoring system, an aeration system, a sludge discharge system, and a control system; the anaerobic tank, the aerobic tank, the anoxic tank, and the sedimentation tank are sequentially communicated; a sludge reflux port of the sedimentation tank is communicated with the anaerobic tank and the anoxic tank through a first sludge reflux pipe and a second sludge reflux pipe respectively;
the monitoring system includes a water inlet flowmeter, a Chemical Oxygen Demand (COD) analyzer, two NH3-N analyzers, a Dissolved Oxygen (DO) monitor, two Mixed Liquor Suspended Solid (MLSS) analyzers, a gas flowmeter, a first reflux sludge flowmeter, a second reflux sludge flowmeter, and a sludge level meter that are all in communication connection with the control system;
the water inlet flowmeter is arranged at a water inlet of the anaerobic tank, and is configured to monitor a water inlet flow rate of raw water; the COD analyzer is arranged at the water inlet of the anaerobic tank, and is configured to monitor a COD concentration of the raw water; the two NH3-N analyzers are respectively arranged at the water inlet of the anaerobic tank and a water outlet of the aerobic tank, and are respectively configured to monitor an NH3-N concentration of the raw water and an NH3-N concentration of wastewater at the water outlet of the aerobic tank; the DO monitor is arranged at the water outlet of the aerobic tank; the two MLSS analyzers are respectively arranged in the anaerobic tank and the anoxic tank; the gas flowmeter is arranged in the aerobic tank, and is configured to monitor an aeration rate of the aeration system; the first reflux sludge flowmeter is arranged on a first sludge reflux pipeline, and is configured to monitor a sludge flow rate that refluxes to the anaerobic tank; the second reflux sludge flowmeter is arranged on a second sludge reflux pipeline, and is configured to monitor a sludge flow rate that refluxes to the anoxic tank; the sludge level meter is arranged in the sedimentation tank, and is configured to monitor a height of a sludge layer;
the aeration system is arranged in the aerobic tank; and the sludge discharge system is communicated with the sedimentation tank.

In an embodiment of the present application, the aeration system includes a aeration fan, an aeration pipeline, and an aeration adjustment valve; the aeration fan is communicated with the aeration pipeline; the aeration adjustment valve is arranged on the aeration pipeline, and is configured to adjust a gas flow rate of the aeration pipeline; an aeration port of the aeration pipeline is arranged in the aerobic tank; and
the aeration fan and the aeration adjustment valve are in communication connection with the control system.

In an embodiment of the present application, the aeration fan is arranged as a variable frequency aeration fan or the aeration adjustment valve is arranged as an electric adjustment valve.

In an embodiment of the present application, the gas flowmeter is arranged on the aeration pipeline.

In an embodiment of the present application, the sludge discharge system includes a sludge discharge pump, a sludge discharge pipeline, and a sludge discharge adjustment valve; the sludge discharge pump is communicated with one end of the sludge discharge pipeline; the other end of the sludge discharge pipeline is communicated with the sedimentation tank; and the sludge discharge adjustment valve is arranged on the sludge discharge pipeline, and is configured to adjust a sludge discharge amount of the sludge discharge pipeline. The sludge discharge adjustment valve is in communication connection with the control system.

In an embodiment of the present application, a first sludge reflux pump and a first sludge reflux adjustment valve are also arranged on the first sludge reflux pipe. The first sludge reflux adjustment valve is configured to adjust a sludge discharge amount of the first sludge reflux pipe. A second sludge reflux pump and a second sludge reflux adjustment valve are also arranged on the second sludge reflux pipe. The second sludge reflux adjustment valve is configured to adjust a sludge discharge amount of the second sludge reflux pipe.

Both the first sludge reflux adjustment valve and the second sludge reflux adjustment valve are in communication connection with the control system.

In an embodiment of the present application, the full-process automatic control system further includes a water inlet system. The water inlet system is communicated with the anaerobic tank, and is configured to input raw water into the anaerobic tank.

In an embodiment of the present application, the water inlet system includes a water inlet pump, a water inlet pipeline, and a water inlet adjustment valve. One end of the water inlet adjustment valve is communicated with the water inlet pump, and the other end is communicated with the anaerobic tank. The water inlet adjustment valve is arranged on the water inlet pipeline, and is configured to adjust a flow rate of the water inlet pipeline. Both the water inlet pump and the water inlet adjustment valve are in communication connection with the control system.

The COD analyzer, the NH3-N analyzers, and the water inlet flowmeter are all arranged on the water inlet pipeline.

In an embodiment of the present application, a stirring mechanism is arranged in each of the anaerobic tank and the anoxic tank.

The present application further provides a full-process automatic control method based on a sludge double recirculation AOA process, which is suitable for the full-process automatic control system based on the sludge double recirculation AOA process. The method includes:
water inlet control, aeration control, sludge reflux control, and sludge discharge control;
the water inlet control includes: acquiring, by the control system, a designed water inlet flow rate value, comparing a real-time water inlet flow rate in the water inlet pipeline collected by the water inlet flowmeter, and adjusting the real-time water inlet flow rate in the water inlet pipeline by adjusting a frequency of the water inlet pump and an opening degree of the water inlet adjustment valve, so that the real-time water inlet flow rate is stabilized at a designed water inlet amount;
the aeration control includes a complete nitrification mode and a short-cut nitrification mode;
the complete nitrification mode includes: acquiring, by the control system, the NH3-N concentration at the water outlet of the aerobic tank to be reached, and calculating a theoretical oxygen supply amount as a feedforward parameter of an oxygen supply amount of the aeration fan on the basis of a theoretical oxygen demand amount formula of complete nitrification according to a COD concentration collected by the COD analyzer and the NH3-N concentration collected by the NH3-N analyzer arranged at the water outlet of the anaerobic tank; modifying, on the basis of a DO prediction model, the theoretical oxygen supply amount by taking the NH3-N concentration collected by the NH3-N analyzer arranged at the water outlet of the aerobic tank and a DO concentration collected by the DO monitor as feedback parameters; adjusting a frequency of the aeration fan and an opening degree of the aeration adjustment valve according to the modified oxygen supply amount;
the short-cut nitrification mode comprises: acquiring, by the control system, the NH3-N concentration at the water outlet of the aerobic tank to be reached, and calculating a theoretical oxygen supply amount as a feedforward parameter of an oxygen supply amount of the aeration fan on the basis of a theoretical oxygen demand amount formula of short-cut nitrification according to a COD concentration collected by the COD analyzer and the NH3-N concentration collected by the NH3-N analyzer arranged at the water outlet of the anaerobic tank; modifying, on the basis of a DO prediction model, the theoretical oxygen supply amount by taking the NH3-N concentration of the aerobic tank collected by the NH3-N analyzer arranged at the water outlet of the aerobic tank and a DO concentration collected by the DO monitor as feedback parameters; adjusting a frequency of the aeration fan and an opening degree of the aeration adjustment valve according to the modified oxygen supply amount;
the sludge reflux control includes: acquiring, by the control system, a set sludge concentration A1 of the anaerobic tank, and collecting, by an MLSS analyzer arranged in the anaerobic tank, a real-time sludge concentration BI of the anaerobic tank, where A1−500≤B1≤A1+500; increasing a frequency of the first sludge reflux pump or an opening degree of the first sludge reflux adjustment valve in a case that B1<A1−500; decreasing a frequency of the first sludge reflux pump or an opening degree of the first sludge reflux adjustment valve in a case that B1>A1+500, where a value range of A1 is 3500 to 5500 mg/L;
acquiring, by the control system, a set sludge concentration A2 of the anoxic tank, collecting, by an MLSS analyzer arranged in the anoxic tank, a real-time sludge concentration B2 of the anoxic tank, and decreasing the frequency of the first sludge reflux pump or the opening degree of the first sludge reflux adjustment valve, so that A2−500≤B2≤A2+500; increasing a frequency of the second sludge reflux pump or an opening degree of the second sludge reflux adjustment valve in a case that B2<A2−500; and decreasing the frequency of the second sludge reflux pump or the opening degree of the second sludge reflux adjustment valve in a case that B2>A2+500, where value range of A2 is 5500 to 8500 mg/L; and
the sludge discharge control comprises: monitoring a height of a sludge layer in real time by using a sludge level meter arranged in a sedimentation tank, acquiring, by the control system, set values of a high sludge discharge level and a low sludge discharge level, and starting a sludge discharge pump in a case that the height of the sludge layer reaches the high sludge discharge level; or shutting down the sludge discharge pump in a case that the height of the sludge layer drops to the high sludge discharge level.

The present application has the following beneficial effects, for example:
1. According to the full-process automatic control system based on the sludge double recirculation AOA process provided by the present application, operation parameters of the sludge double recirculation AOA process are controlled more intelligently, so that the process is kept at the optimal operation parameters, meanwhile, the energy consumption is reduced, the control is flexible, the operations are convenient, the manual operations are reduced, and the operation efficiency is improved.
2. The sludge double recirculation AOA process implements short-cut nitrification easily under suitable conditions. An aeration control mode provided by the present application includes a complete nitrification mode and a short-cut nitrification mode, which are set flexibly, and facilitates process cultivation and domestication of short-cut nitrification.
3. A sludge reflux amount is adjusted and controlled on the basis of a sludge concentration based on the characteristics of the sludge double recirculation AOA process, which can ensure efficient microbial reactions and reduce energy consumption of sludge reflux. The microbial reaction rate is related to the sludge concentration. The sludge reflux amount is traditionally adjusted and controlled by a reflux ratio. However, the concentration of the reflux sludge will change due to situations of sludge discharge and the like, resulting in an unstable sludge concentration in a reactor. Too low sludge concentration in the reactor cannot ensure efficient biological reaction and affects an effluent quality; and too high sludge concentration in the reactor will result in energy waste due to an excessive reflux amount.
4. The sludge level meter controls the height of the sludge layer, sludge is discharged in time, and a phenomenon of floating sludge caused by a too-high sludge layer is avoided.

### BRIEF DESCRIPTION OF THE DRAWINGS

To describe technical solutions in embodiments of the present application more clearly, the following briefly introduces the drawings required for describing the embodiments. It is to be understood that the following drawings only show some embodiments of the present application, and therefore cannot be considered as a limitation to a scope. Those of ordinary skill in the art may still obtain other relevant drawings according to these drawings without creative efforts.

FIG. 1 is a schematic structural diagram of a full-process automatic control system based on a sludge double recirculation AOA process provided by the present application.

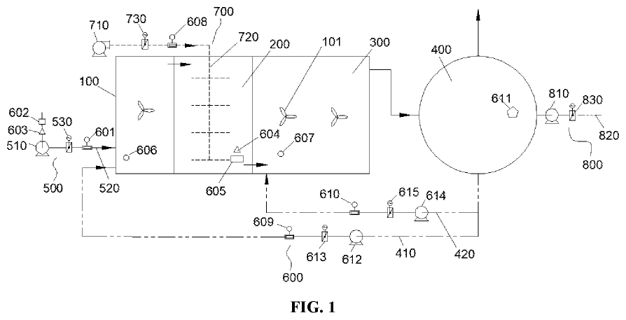

### REFERENCE SIGNS IN THE DRAWINGS

101—stirring mechanism; 100—anaerobic tank; 200—aerobic tank; 300—anoxic tank; 400—sedimentation tank; 410—first sludge reflux pipe; 420—second sludge reflux pipe; 500—water inlet system; 510—water inlet pump; 520—water inlet pipeline; 530—water inlet adjustment valve; 600—monitoring system; 601—water inlet flowmeter; 602—COD analyzer; 603—first NH3-N analyzer; 604—second NH3-N analyzer; 605—DO monitor; 606—first MLSS analyzer; 607—second MLSS analyzer; 608—gas flowmeter; 609—first reflux sludge flowmeter; 610—second reflux sludge flowmeter; 611—sludge level meter; 612—first sludge reflux pump; 613—first sludge reflux adjustment valve; 614—second sludge reflux pump; 615—second sludge reflux adjustment valve; 700—aeration system; 710—aeration fan; 720—aeration pipeline; 730—aeration adjustment valve; 800—sludge discharge system; 810—sludge discharge pump; 820—sludge discharge pipeline; and 830—sludge discharge adjustment valve.

### DETAILED DESCRIPTION OF THE EMBODIMENTS

To make the objectives, technical solutions, and advantages of the embodiments of the present application clearer, the following clearly and completely describes the technical solutions in the embodiments of the present application with reference to the drawings in the embodiments of the present application. Apparently, the described embodiments are part rather than all of the embodiments of the present application. The components of the embodiments of the present application, which are described and shown in the drawings herein, may be arranged and designed in a variety of different configurations.

Therefore, the following detailed description of the embodiments of the present application provided in the drawings is not intended to limit the scope of protection of the present application, but only represents the selected embodiments of the present application. All other embodiments obtained by those of ordinary skill in the art based on the embodiments of this application without creative efforts fall within the scope of protection of this application.

It is to be noted that embodiments in the present application and features in the embodiments may be combined without a conflict.

It is to be noted that similar reference signs and letters represent similar terms in the following drawings and thus a certain term, once being defined in a drawing, is not required to be further defined and explained in subsequent drawings.

In the descriptions of the embodiments of the present application, it is to be noted that indicated orientations or positional relationships are based on the orientations or positional relationships shown in the drawings, or the orientations or positional relationships of the product of the present application that is habitually placed when used, or the orientations or positional relationships that are commonly understood by those skilled in the art, or the orientations or positional relationship of the product of the present application that is habitually placed when used, are only intended to facilitate the descriptions of the present application and simplifying the descriptions, rather than indicating or implying that a referred full-process automatic control system based on a sludge double recirculation AOA process or element must have a specific orientation and must be constructed and operated in a specific orientation, and therefore cannot be understood as a limitation to the present application. In addition, terms “first”, “second”, “third”, and the like are only used for distinguishing descriptions, and cannot be understood as indicating or implying relative importance.

In the descriptions of the present application, it is also to be noted that, unless otherwise specified and defined explicitly, terms “arranged”, “mounted”, and “connected” are to be interpreted broadly, for example, may be fixedly connected, or detachably connected, or integrally connected, may be directly connecting, or indirectly connected through an intermediate medium. Those of ordinary skill in the art may understand specific meanings of the above terms in the present application in specific situations.

The present application provides a full-process automatic control system based on a sludge double recirculation AOA process. It is to be understood that the sludge double recirculation AOA process is a novel efficient denitrification process, that is, the full-process automatic control system provided by the present embodiment is based on an efficient denitrification wastewater treatment system, and is used for an efficient denitrification process. The efficient denitrification wastewater treatment system includes an anaerobic tank 100, an aerobic tank 200, an anoxic tank 300, and a sedimentation tank 400 that are sequentially communicated. A sludge reflux port of the sedimentation tank 400 is communicated with the anaerobic tank 100 and the anoxic tank 300 through a first sludge reflux pipe 410 and a second sludge reflux pipe 420 respectively. Raw water enters the anaerobic tank 100, and then flows through the aerobic tank 200, the anoxic tank 300, and the sedimentation tank 400 in sequence. Part sludge in the sedimentation tank 400 enters the anaerobic tank 100 through the first sludge reflux pipe 410, and part sludge enters the anoxic tank 300 through the second sludge reflux pipe 420.

The full-process automatic control system provided by the present embodiment further includes a water inlet system 500, a monitoring system 600, an aeration system 700, a sludge discharge system 800, and a control system. The water inlet system 500 is configured to input raw water into the anaerobic tank 100. The monitoring system 600 is configured to monitor various parameters of wastewater and sludge in each treatment tank. The aeration system 700 provides an appropriate amount of oxygen for the aerobic tank 200. The sludge discharge system 800 is configured to discharge the sludge from the sedimentation tank 400. The control system achieves the effects of global monitoring and controlling.

In the present embodiment, the water inlet system 500 includes a water inlet pump 510, a water inlet pipeline 520, and a water inlet adjustment valve 530. One end of the water inlet adjustment valve 530 is communicated with the water inlet pump 510, and the other end is communicated with the anaerobic tank 100. The water inlet pump 510 is configured to input raw water into the anaerobic tank 100 through the water inlet pipeline 520. The water inlet adjustment valve 530 is arranged on the water inlet pipeline 520, and is configured to adjust a flow rate of the water inlet pipeline 520. Apparently, the water inlet pipeline 520 may also be directly closed. Both the water inlet pump 510 and the water inlet adjustment valve 530 are in communication connection with the control system. For example, the water inlet pump 510 and the water inlet adjustment valve 530 are in communication connection with the control system through a power line and a local area network to control the water inlet pump 510 and the water inlet adjustment valve 530 through the control system.

In the present embodiment, optionally, the monitoring system 600 includes a water inlet flowmeter 601, a COD analyzer 602, a first NH3-N analyzer 603, a second NH3-N analyzer 604, a DO monitor 605, a first MLSS analyzer 606, a second MLSS analyzer 607, a gas flowmeter 608, a first reflux sludge flowmeter 609, a second reflux sludge flowmeter 610, and a sludge level meter 611 that are all in communication connection with the control system.

Specifically, the water inlet flowmeter 601, the COD analyzer 602, the first NH3-N analyzer 603, and the water inlet adjustment valve 530 are all arranged on the water inlet pipeline 520 that is communicated with the anaerobic tank 100. The water inlet flowmeter 601 is configured to monitor a water inlet flow rate of the raw water. The COD analyzer 602 is configured to monitor a COD concentration of the raw water. The first NH3-N analyzer 603 is configured to monitor an NH3-N concentration of the raw water. The water inlet adjustment valve 530 is configured adjust a flow rate of the water inlet pipeline 520. Moreover, the COD analyzer 602, the first NH3-N analyzer 603, the water inlet pump 510, the water inlet adjustment valve 530, and the water inlet flowmeter 601 are sequentially arranged on the water inlet pipeline 520. The water inlet flowmeter 601 is closest to one end, communicated with the anaerobic tank 100, of the water inlet pipeline 520. Both the second NH3-N analyzer 604 and the DO monitor 605 are arranged at the water outlet of the aerobic tank 200. The second NH3-N analyzer 604 is configured to monitor an NH3-N concentration of wastewater at the water outlet of the aerobic tank 200. The first MLSS analyzer 606 is arranged in the anaerobic tank 100. The second MLSS analyzer 607 is arranged in the anoxic tank 300. The gas flowmeter 608 is arranged in the aerobic tank 200, and is configured to monitor an aeration rate of the aeration system 700 arranged in the aerobic tank 200. The first reflux sludge flowmeter 609 is arranged on the first sludge reflux pipe 410, and is configured to monitor a sludge flow rate that refluxes to the anaerobic tank 100; the second reflux sludge flowmeter 610 is arranged on the second sludge reflux pipeline 420, and is configured to monitor a sludge flow rate that refluxes to the anoxic tank 300; and the sludge level meter 611 is arranged in the sedimentation tank 400, and is configured to monitor a height of a sludge layer.

Optionally, the first sludge reflux pump 612 and the first sludge reflux adjustment valve 613 are also arranged on the first sludge reflux pipe 410. The first sludge reflux adjustment valve 613 is configured to adjust a reflux sludge amount of the first sludge reflux pipe 410. The second sludge reflux pump 614 and the second sludge reflux adjustment valve 615 are also arranged on the second reflux pipe 420. The second sludge reflux adjustment valve 615 is configured to adjust a reflux sludge amount of the second reflux pipe 420. Both the first sludge reflux adjustment valve 613 and the second sludge reflux adjustment valve 615 are in communication connection with the control system.

In the present embodiment, optionally, the aeration system 700 includes a aeration fan 710, an aeration pipeline 720, and an aeration adjustment valve 730. The aeration fan 710 is communicated with the aeration pipeline 720. The aeration adjustment valve 730 is arranged on the aeration pipeline 720, and is configured to adjust a gas flow rate of the aeration pipeline 720. An aerator of the aeration pipeline 720 is arranged in the aerobic tank 200. The aeration fan 710 and the aeration adjustment valve 730 are in communication connection with the control system. It is to be noted that the aeration fan 710 may be arranged as a variable frequency aeration fan 710, or the aeration adjustment valve 730 is arranged as an electric adjustment valve. Moreover, the gas flowmeter 608 may be directly arranged on the aeration pipeline 720.

In the present embodiment, optionally, the sludge discharge system 800 includes a sludge discharge pump 810, a sludge discharge pipeline 820, and a sludge discharge adjustment valve 830. The sludge discharge pump 810 is communicated with one end of the sludge discharge pipeline 820, and the other end of the sludge discharge pipeline 820 is communicated with the sedimentation tank 400. The sludge discharge adjustment valve 830 is arranged on the sludge discharge pipeline 820, and is configured to adjust a sludge discharge amount of the sludge discharge pipeline 820. The sludge discharge adjustment valve 830 is in communication connection with the control system.

In the present embodiment, optionally, the control system may be a Programmable Logic Controller (PLC) control system.

In other embodiments, a stirring mechanism 101 may be arranged in each of the anaerobic tank 100 and the anoxic tank 300, which facilitates mixing of wastewater.

The present embodiment further provide a full-process automatic control method based on a sludge double recirculation AOA process, including:
water inlet control, aeration control, sludge reflux control, and sludge discharge control;
the water inlet control includes: the control system acquires a designed water inlet flow rate value, for example, a water inlet flow rate value may be input manually, compares a real-time water inlet flow rate in the water inlet pipeline 520 collected by the water inlet flowmeter 601, and adjusts the real-time water inlet flow rate of the water inlet pipeline 520 by adjusting a frequency of the water inlet pump 510 and an opening degree of the water inlet adjustment valve 530, so that the real-time water inlet flow rate is stabilized at a designed water inlet amount;
the aeration control includes a complete nitrification mode and a short-cut nitrification mode;
the complete nitrification mode includes: the control system acquires the NH3-N concentration at the water outlet of the aerobic tank 200 to be reached, for example, the NH3-N concentration to be reached may be input manually, calculates a theoretical oxygen supply amount as a feedforward parameter of an oxygen supply amount of the aeration fan 710 on the basis of a theoretical oxygen demand amount formula of complete nitrification according to a COD concentration collected by the COD analyzer 602 and the NH3-N concentration collected by the NH3-N analyzer arranged at the water outlet of the anaerobic tank 100, modifies, on the basis of a DO prediction model, the theoretical oxygen supply amount by taking the NH3-N concentration collected by the NH3-N analyzer arranged at the water outlet of the aerobic tank 200 and a DO concentration collected by the DO monitor 605 as feedback parameters, and adjusts a frequency of the aeration fan 710 and an opening degree of the aeration adjustment valve 730 according to the modified oxygen supply amount;
the short-cut nitrification mode includes: the control system acquires the NH3-N concentration at the water outlet of the aerobic tank 200 to be reached, for example, the NH3-N concentration to be reached may be input manually, calculates a theoretical oxygen supply amount as a feedforward parameter of an oxygen supply amount of the aeration fan 710 on the basis of a theoretical oxygen demand amount formula of short-cut nitrification according to a COD concentration collected by the COD analyzer 602 and the NH3-N concentration collected by the NH3-N analyzer arranged at the water outlet of the anaerobic tank 100, modifies, on the basis of a DO prediction model, the theoretical oxygen supply amount by taking the NH3-N concentration of the aerobic tank 200 collected by the NH3-N analyzer arranged at the water outlet of the aerobic tank 200 and a DO concentration collected by the DO monitor 605 as feedback parameters, and adjusts a frequency of the aeration fan 710 and an opening degree of the aeration adjustment valve 730 according to the modified oxygen supply amount;
the sludge reflux control includes: the control system acquires a set sludge concentration A1 of the anaerobic tank 100, for example, the sludge concentration A1 to be reached may be input manually, and an MLSS analyzer arranged in the anaerobic tank 100 collects a real-time sludge concentration B1 of the anaerobic tank 100, where A1−500≤B1≤A1+500; a frequency of the first sludge reflux pump 612 or an opening degree of the first sludge reflux adjustment valve 613 is increased in a case that B1<A1−500; the frequency of the first sludge reflux pump 612 or the opening degree of the first sludge reflux adjustment valve 613 is decreased in a case that B1>A1+500, where a value range of A1 is 3500 to 5500 mg/L;
the control system acquires a set sludge concentration A2 of the anoxic tank 300, for example, the sludge concentration A2 to be reached may be input manually, and an MLSS analyzer arranged in the anoxic tank 300 collects a real-time sludge concentration B2 of the anoxic tank 300; the frequency of the first sludge reflux pump 612 or the opening degree of the first sludge reflux adjustment valve 613 is decreased, so that A2−500≤B2≤A2+500; a frequency of the second sludge reflux pump 614 or an opening degree of the second sludge reflux adjustment valve 615 is increased in a case that B2<A2−500; a frequency of the second sludge reflux pump 614 or an opening degree of the second sludge reflux adjustment valve 615 is decreased in a case that B2>A2+500, where a value range of A2 is 5500 to 8500 mg/L; and
the sludge discharge control includes: a height of a sludge layer is monitored in real time by using a sludge level meter 611 arranged in the sedimentation tank 400; the control system acquires set values of a high sludge discharge level and a low sludge discharge level; a sludge discharge pump 810 is started in a case that the height of the sludge layer reaches the high sludge discharge level; or the sludge discharge pump 810 is shut down in a case that the height of the sludge layer drops to the high sludge discharge level.

The full-process automatic control system based on the sludge double recirculation AOA process provided by the present embodiment at least has the following beneficial effects:
1. According to the full-process automatic control system based on the sludge double recirculation AOA process provided by the present application, operation parameters of the sludge double recirculation AOA process are controlled more intelligently, so that the process is kept at the optimal operation parameters, meanwhile, the energy consumption is reduced, the control is flexible, the operations are convenient, the manual operations are reduced, and the operation efficiency is improved.
2. The sludge double recirculation AOA process implements short-cut nitrification easily under suitable conditions. An aeration control mode provided by the present application includes a complete nitrification mode and a short-cut nitrification mode, which are set flexibly, and facilitates process cultivation and domestication of short-cut nitrification.
3. A sludge reflux amount is adjusted and controlled on the basis of a sludge concentration based on the characteristics of the sludge double recirculation AOA process, which can ensure efficient microbial reactions and reduce energy consumption of sludge reflux. The microbial reaction rate is related to the sludge concentration. The sludge reflux amount is traditionally adjusted and controlled by a reflux ratio. However, the concentration of the reflux sludge will change due to situations of sludge discharge and the like, resulting in an unstable sludge concentration in a reactor. Too low sludge concentration in the reactor cannot ensure efficient biological reaction and affects an effluent quality; and too high sludge concentration in the reactor will result in energy waste due to an excessive reflux amount.
4. The sludge level meter 611 controls the height of the sludge layer, sludge is discharged in time, and a phenomenon of floating sludge caused by a too-high sludge layer is avoided.

The above are only preferred embodiments of the present application, and is not intended to limit the present application. For those skilled in the art, the present application may have various changes and variations. Any modifications, equivalent replacements, improvements and the like made within the spirit and principle of the present application fall within the scope of protection of the present application.

What is claimed is:

1. A full-process automatic control system based on a sludge double recirculation Anaerobic- Anoxic-Oxic (AOA) process, comprising:
an anaerobic tank, an aerobic tank, an anoxic tank, a sedimentation tank, a monitoring system, an aeration system, a sludge discharge system, and a control system, wherein the anaerobic tank, the aerobic tank, the anoxic tank, and the sedimentation tank are sequentially communicated; a sludge reflux port of the sedimentation tank is communicated with the anaerobic tank and the anoxic tank through a first sludge reflux pipe and a second sludge reflux pipe respectively;
the monitoring system comprises a water inlet flowmeter, a Chemical Oxygen Demand (COD) analyzer, two NH3-N analyzers, a Dissolved Oxygen (DO) monitor, two Mixed Liquor Suspended Solid (MLSS) analyzers, a gas flowmeter, a first reflux sludge flowmeter, a second reflux sludge flowmeter, and a sludge level meter that are all in communication connection with the control system;
the water inlet flowmeter is arranged at a water inlet of the anaerobic tank, and is configured to monitor a water inlet flow rate of raw water; the COD analyzer is arranged at the water inlet of the anaerobic tank, and is configured to monitor a COD concentration of the raw water; the two NH3-N analyzers are respectively arranged at the water inlet of the anaerobic tank and a water outlet of the aerobic tank, and are respectively configured to monitor an NH3-N concentration of the raw water and an NH3-N concentration of wastewater at the water outlet of the aerobic tank; the DO monitor is arranged at the water outlet of the aerobic tank; the two MLSS analyzers are respectively arranged in the anaerobic tank and the anoxic tank; the gas flowmeter is arranged on an aeration pipeline, and is configured to monitor an aeration rate of the aeration system; the first reflux sludge flowmeter is arranged on a first sludge reflux pipeline, and is configured to monitor a sludge flow rate that refluxes to the anaerobic tank; the second reflux sludge flowmeter is arranged on a second sludge reflux pipeline, and is configured to monitor a sludge flow rate that refluxes to the anoxic tank; the sludge level meter is arranged in the sedimentation tank, and is configured to monitor a height of a sludge layer;
the aeration system is connected to the aerobic tank; and the sludge discharge system is communicated with the sedimentation tank.

2. The full-process automatic control system based on the sludge double recirculation AOA process according to claim 1, wherein
the aeration system comprises a aeration fan, the aeration pipeline, and an aeration adjustment valve; the aeration fan is communicated with the aeration pipeline; the aeration adjustment valve is arranged on the aeration pipeline, and is configured to adjust a gas flow rate of the aeration pipeline; an aeration port of the aeration pipeline is arranged in the aerobic tank; and
the aeration fan and the aeration adjustment valve are in communication connection with the control system.

3. The full-process automatic control system based on the sludge double recirculation AOA process according to claim 2, wherein
the aeration fan is arranged as a variable frequency aeration fan or the aeration adjustment valve is arranged as an electric adjustment valve.

4. The full-process automatic control system based on the sludge double recirculation AOA process according to claim 2, wherein
the gas flowmeter is arranged on the aeration pipeline.

5. The full-process automatic control system based on the sludge double recirculation AOA process according to claim 1, wherein
the sludge discharge system comprises a sludge discharge pump, a sludge discharge pipeline, and a sludge discharge adjustment valve; the sludge discharge pump is communicated with one end of the sludge discharge pipeline; the other end of the sludge discharge pipeline is communicated with the sedimentation tank; and the sludge discharge adjustment valve is arranged on the sludge discharge pipeline, and is configured to adjust a sludge discharge amount of the sludge discharge pipeline.

6. The full-process automatic control system based on the sludge double recirculation AOA process according to claim 1, wherein
a first sludge reflux pump and a first sludge reflux adjustment valve are also arranged on the first sludge reflux pipe; the first sludge reflux adjustment valve is configured to adjust a sludge discharge amount of the first sludge reflux pipe; a second sludge reflux pump and a second sludge reflux adjustment valve are also arranged on the second sludge reflux pipe; the second sludge reflux adjustment valve is configured to adjust a sludge discharge amount of the second sludge reflux pipe; and
both the first sludge reflux adjustment valve and the second sludge reflux adjustment valve are in communication connection with the control system.

7. The full-process automatic control system based on the sludge double recirculation AOA process according to claim 1, wherein
the full-process automatic control system further comprises a water inlet system; and the water inlet system is communicated with the anaerobic tank, and is configured to input raw water into the anaerobic tank.

8. The full-process automatic control system based on the sludge double recirculation AOA process according to claim 7, wherein
the water inlet system comprises a water inlet pump, a water inlet pipeline, and a water inlet adjustment valve; one end of the water inlet adjustment valve is communicated with the water inlet pump, and the other end is communicated with the anaerobic tank; the water inlet adjustment valve is arranged on the water inlet pipeline, and is configured to adjust a flow rate of the water inlet pipeline; both the water inlet pump and the water inlet adjustment valve are in communication connection with the control system; and
the COD analyzer, the NH3-N analyzers, and the water inlet flowmeter are all arranged on the water inlet pipeline.

9. The full-process automatic control system based on the sludge double recirculation AOA process according to claim 1, wherein
a stirring mechanism is arranged in each of the anaerobic tank and the anoxic tank.

10. A full-process automatic control method based on a sludge double recirculation AOA process, suitable for the full-process automatic control system based on the sludge double recirculation AOA process according to claim 1, comprising:
water inlet control, aeration control, sludge reflux control, and sludge discharge control, wherein
the water inlet control comprises: acquiring, by the control system, a designed water inlet flow rate value, comparing a real-time water inlet flow rate of the water inlet pipeline collected by the water inlet flowmeter, and adjusting the real-time water inlet flow rate of the water inlet pipeline by adjusting a frequency of the water inlet pump and an opening degree of the water inlet adjustment valve, so that the real-time water inlet flow rate is stabilized at a designed water inlet amount;
the aeration control comprises a complete nitrification mode and a short-cut nitrification mode, wherein
the complete nitrification mode comprises: acquiring, by the control system, the NH3-N concentration at the water outlet of the aerobic tank to be reached, and calculating a theoretical oxygen supply amount as a feedforward parameter of a gas supply amount of the aeration fan on the basis of a theoretical oxygen demand amount formula of complete nitrification according to a COD concentration collected by the COD analyzer and the NH3-N concentration collected by the NH3-N analyzer arranged at the water outlet of the anaerobic tank; modifying, on the basis of a DO prediction model, the theoretical oxygen supply amount by taking the NH3-N concentration collected by the NH3-N analyzer arranged at the water outlet of the aerobic tank and a DO concentration collected by the DO monitor as feedback parameters; and adjusting a frequency of the aeration fan and an opening degree of the aeration adjustment valve according to the modified oxygen supply amount;
the short-cut nitrification mode comprises: acquiring, by the control system, the NH3-N concentration at the water outlet of the aerobic tank to be reached, and calculating a theoretical oxygen supply amount as a feedforward parameter of an oxygen supply amount of the aeration fan on the basis of a theoretical oxygen demand amount formula of short-cut nitrification according to the COD concentration collected by the COD analyzer and the NH3-N concentration collected by the NH3-N analyzer arranged at the water outlet of the anaerobic tank; modifying, on the basis of a DO prediction model, the theoretical oxygen supply amount by taking the NH3-N concentration of the aerobic tank collected by the NH3-N analyzer arranged at the water outlet of the aerobic tank and a DO concentration collected by the DO monitor as feedback parameters; adjusting a frequency of the aeration fan and an opening degree of the aeration adjustment valve according to the modified oxygen supply amount;
the sludge reflux control comprises: acquiring, by the control system, a set sludge concentration A1 of the anaerobic tank, and collecting, by an MLSS analyzer arranged in the anaerobic tank, a real-time sludge concentration BI of the anaerobic tank, wherein A1−500≤B1≤A1+500; increasing a frequency of the first sludge reflux pump or an opening degree of the first sludge reflux adjustment valve in a case that B1<A1−500; decreasing the frequency of the first sludge reflux pump or the opening degree of the first sludge reflux adjustment valve in a case that B1>A1+500, wherein a value range of A1 is 3500 to 5500 mg/L;
acquiring, by the control system, a set sludge concentration A2 of the anoxic tank, collecting, by an MLSS analyzer arranged in the anoxic tank, a real-time sludge concentration B2 of the anoxic tank, and decreasing the frequency of the first sludge reflux pump or the opening degree of the first sludge reflux adjustment valve, so that A2−500≤B2≤A2+500; increasing a frequency of the second sludge reflux pump or an opening degree of the second sludge reflux adjustment valve in a case that B2<A2−500; decreasing the frequency of the second sludge reflux pump or the opening degree of the second sludge reflux adjustment valve in a case that B2>A2+500, wherein value range of A2 is 5500 to 8500 mg/L; and
the sludge discharge control comprises: monitoring a height of a sludge layer in real time by using the sludge level meter arranged in the sedimentation tank, acquiring, by the control system, set values of a high sludge discharge level and a low sludge discharge level, and starting a sludge discharge pump in a case that the height of the sludge layer reaches the high sludge discharge level;
or shutting down the sludge discharge pump in a case that the height of the sludge layer drops to the high sludge discharge level.
